(19) United States
(12) Patent Application Publication
(10) Pub. No.: US 2023/0390881 A1
(43) Pub. Date: Dec. 7, 2023

(54) REUSABLE HUB ASSEMBLY FOR ABRASIVE ARTICLES

(71) Applicant: 3M INNOVATIVE PROPERTIES COMPANY, St. Paul, MN (US)

(72) Inventors: Brett A. Beiermann, St. Paul, MN (US); Maiken Givot, St. Paul, MN (US); Jean-Luc Rifaut, Brussels (BE)

(21) Appl. No.: 18/250,280

(22) PCT Filed: Oct. 25, 2021
(86) PCT No.: PCT/IB2021/059828

§ 371 Date: Apr. 24, 2023

Related U.S. Application Data
(60) Provisional application No. 63/198,574, filed on Oct. 28, 2020.

(51) Int. Cl. B24B 23/02; B25F 5/00

(52) U.S. Cl. CPC B24B 23/02; B25F 5/006

(57) ABSTRACT

A method providing damping during an abrading operation is provided. The method includes removably coupling the abrasive wheel to a hub. The abrasive wheel has an outer circumference and an inner circumference. A layer of abrasive material extends between the inner and outer circumference. The method also includes abrading a worksurface by contacting the abrasive disc to the worksurface. The hub includes a housing and a plurality of damping units within the housing. The plurality of damping units are shaped to reduce vibrations during a grinding operation.

### BACKGROUND

Bonded abrasive wheels are typically provided with an attachment mechanism for connecting to a grinding system. The attachment mechanism may include a generally cylindrical aperture bushing A disc shaped flange extends radially from a medial portion of the bushing and terminates at a peripheral lip. The bushing is adapted to extend through a central bore of the wheel so that the lip engages the backing face of the wheel proximate an outermost circumference of the depressed center. A grinding face end of the bushing extends radially outward to engage the front grinding face of the wheel and mechanically capture the wheel between the grinding face end and the flange. The flange, lip and backing face form a cavity into which epoxy resin is placed to chemically bond the hub to the wheel.

### SUMMARY

A method providing damping during an abrading operation is provided. The method includes removably coupling the abrasive wheel to a hub. The abrasive wheel has an outer circumference and an inner circumference. A layer of abrasive material extends between the inner and outer circumference. The method also includes abrading a worksurface by contacting the abrasive disc to the worksurface. The hub includes a housing and a plurality of damping units within the housing. The plurality of damping units are shaped to reduce vibrations during a grinding operation.

Systems and methods herein provide significant waste reduction compared to contemporary hubs for abrasive systems. Systems herein allow for a savings of up to 30% of the volume of an abrasive disc that is available for abrading and not thrown out. Additionally, the system herein provides for a hub that is reusable for multiple abrasive discs, reducing waste.

Systems and methods herein also provide improved damping of vibration caused by an abrading operation. Further, a better consistency of cut is provided using hubs illustrated herein, in part due to improved damping of vibrations caused during a grinding operation.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIGS. 1A-1B illustrate a depressed center grinding wheel without, and with, a metal hub.

FIGS. 2A-2B illustrate cutaway views of reusable hub assemblies in accordance with embodiments herein.

FIGS. 3A-3D illustrate internal views of a reusable hub assembly in accordance with embodiments herein.

FIGS. 4A-4L illustrate damping features for a reusable hub assembly in accordance with embodiments herein.

FIG. 5 illustrates a block diagram illustrating components of a reusable hub in accordance with embodiments herein.

FIG. 6 illustrates a method of using a reusable hub in accordance with embodiments herein.

FIG. 7 illustrates a method of abrading a workpiece in accordance with embodiments herein.

FIG. 8 illustrates a method of making a reusable hub using additive manufacturing techniques.

FIGS. 9-18 illustrate damping structures and analysis related thereto discussed in greater detail in the Examples.

### DETAILED DESCRIPTION

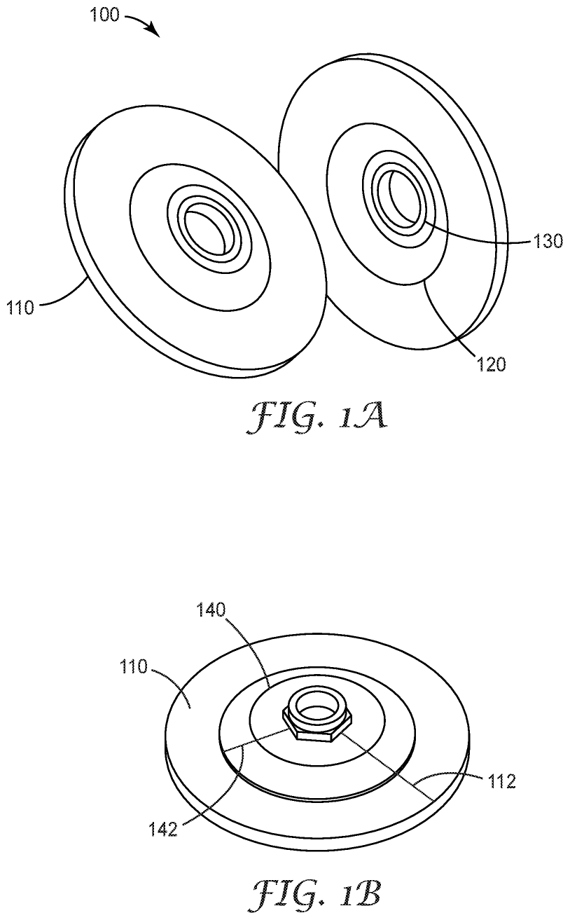

Depressed center grinding wheels are one example of an abrasive article that can be used in a grinding operation. Many grinding wheels are used with a hub for mounting to a grinding assembly. FIG. 1A illustrates an exemplary depressed center grinding wheel of the prior art, and FIG. 1B illustrates such a wheel with a metal hub attached thereto.

U.S. Pat. No. 5,895,317, issued on Apr. 20, 1999, describes prior art hub assemblies for abrasive articles, specifically depressed center grinding wheels such as that illustrated in FIGS. 1A and 1B. Typically, the hub is attached to the wheel using an adhesive. The hub overlaps a portion of the abrasive article's surface, at least on the side it is adhered to.

Unfortunately, this means that a user can only grind up to the edge of the hub. the outer diameter becomes smaller until the wheel is too small to use. As the wheel diameter becomes significantly smaller, the radial speed of the wheel decreases significantly, and the performance degrades. Particularly for depressed center grinding wheels, the “depressed center” portion of the wheel is often discarded by the user. The discarded portion can be a significant fraction of the total material. For example, more than 30% of a 4.5″ outer diameter CII DCGW is in the often-discarded depressed center portion. Additionally, because the hub is discarded, it is not reusable.

It is desired to reduce the amount of wasted abrasive material, both from a raw materials concern as well as an environmental waste concern. Additionally, it is desired to have a reusable hub that can be releasably connected to an abrasive article and reused from grinding operation to grinding operation. Ideally, the re-useable hub is made of a material that provides sufficient stability. Additionally, it is desired that hub could be mated to an appropriate spindle as needed.

FIGS. 1A-1B illustrate a depressed center grinding wheel (DCW) without, and with, a metal hub. An abrasive layer 110 has a depression 120 that a hub 140 can attach to. A connection ring 130 facilitates insertion of a drive shaft through the abrasive article. Hub 140 is metal and adhered to the surface of wheel 110.

As illustrated in FIG. 1B, a portion of abrasive wheel 110 represented by radius portion 142 is covered by the surface area of hub 140. Portion 142 is discarded after use as it is unusably coupled to hub 140. It is desired that the entire area of wheel 110, represented by radius portion 112, is usable during a grinding operation.

It is noted that DCWs also have poorer performance as the product nears the end of its life and wheel 110 is ground down to the edge of hub 140. This is exhibited in both cut consistency and rate of degradation of the wheel. Embodiments herein provide improved cut consistency as well as reduced waste during manufacturing and use.

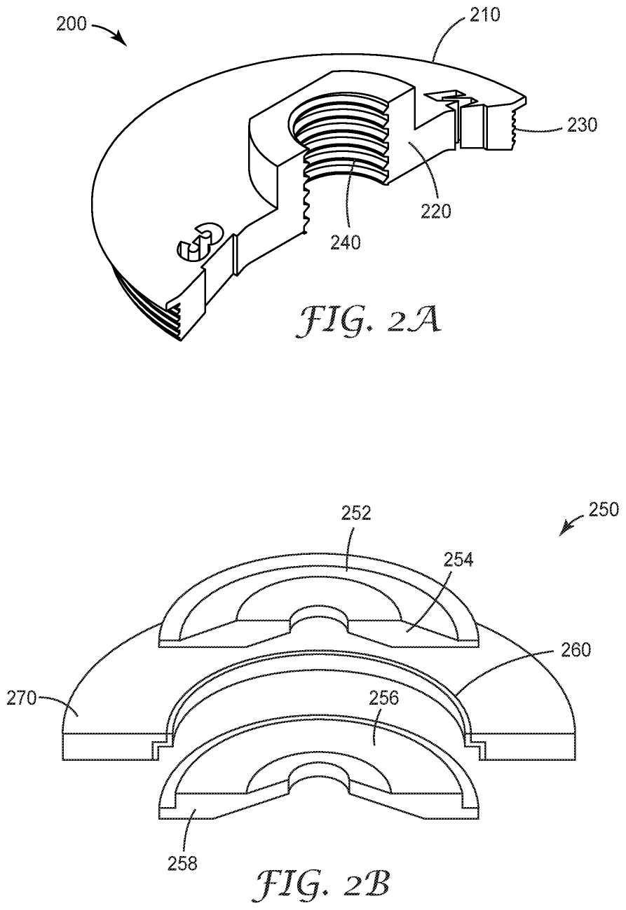

FIGS. 2A-BC illustrate cutaway views of reusable hub assemblies in accordance with embodiments herein. FIG. 2A illustrates a single component hub 200, while FIG. 2B illustrates a two-component hub 250 coupled to a grinding wheel 270.

FIG. 2A illustrates a cutaway view of a hub 200 with a housing 210 and an interior 220. Interior 320, in one embodiment, is the same material as the housing, and is designed to reduce vibrations during use. In another embodiment, interior 220 is a different material than housing 210, but is a material designed to reduce vibrations. Hub 200 illustrates a threaded connection 340 for coupling to a drive shaft of a tool. Additionally, a threaded connection 230 is also illustrated for coupling to a mating ring, for example, or directly into corresponding threading in an abrasive article. However, other connection mechanisms are expressly contemplated.

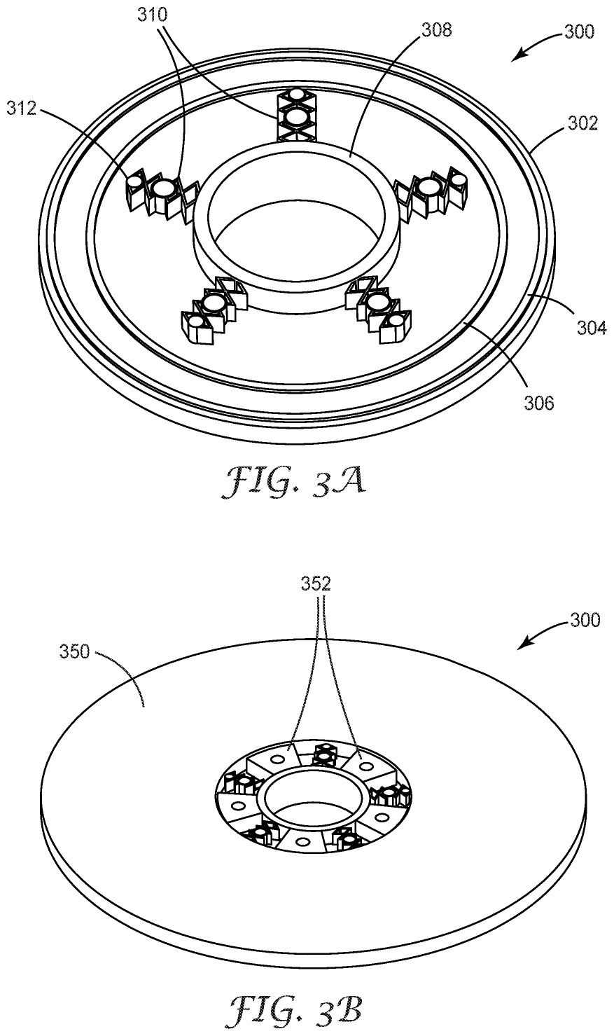

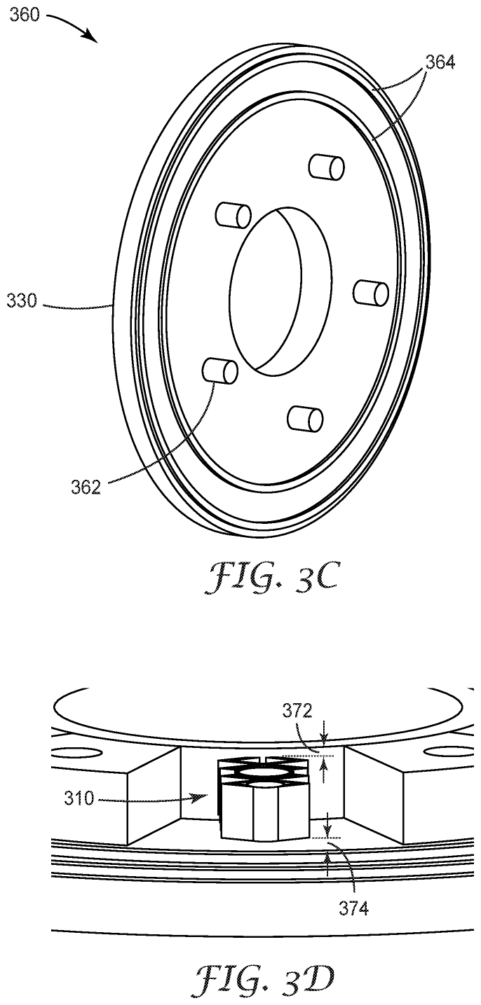

FIG. 2B illustrates a cutaway view of a hub assembly 250. Hub assembly includes two different hub components, a top component 252, and a bottom component 256. Top component 252 has an interior 254 with a damping material, and bottom component 256 also contains damping material 258. Top component 252 and bottom component 256 both are received by a mating ring 260, illustrated in the embodiment of FIG. 3B. However, it is expressly contemplated that, in some embodiments, a mating ring 260 is not required.

Described herein are multiple embodiments of damping structures that may be useful in either a single-component hub construction, like that of FIG. 2A, or a multi-component hub construction, like that of FIG. 2B. Additionally, while a multi-component construction may be the result of an additive manufacturing process, a customer may interact with an assembled hub that behaves like a single-component construction. Both embodiments are expressly contemplated as possible housings for damping structures described herein.

The present system is an improvement over previous designs, such as that of U.S. Pat. No. 6,454,639 issued on Sep. 24, 2002. The design illustrated herein includes two components outside of the grinding wheel that connect together by threading. Mating ring 230 and hub 220 have a depth that extends throughout the entire grinding layer 210, which offers a simpler design for manufacturing and use, and provides the stability desired by the inventors of U.S. Pat. No. 6,454,639 without the need for the included damping layers and use of glue to adhere clamping components together. The design also provides a simpler connection between the hub 220 and a drive shaft of a tool, as the hub 220 is the only portion of the assembly 200 that couples to the drive shaft.

It is also noted that, compared to contemporary designs, the assembled wheel 250 provides sustainability benefits. While there is a slight overlap between hub components 254, 256 and grinding layer 270, the design presents a significant improvement in waste reduction of abrasive material. And many designs herein, as discussed in the Examples, provide improved damping.

FIGS. 3A-3D illustrate internal views of a reusable hub assembly in accordance with embodiments herein. Hub 300 includes several features that provide increased damping of vibration. Hub 300 has a housing 302 which includes a disconnecting feature 304 which separates an abrasive wheel attached to hub 300 from a machine shaft. In some embodiments, a second disconnecting feature 306 is also present. Disconnecting features 304, 306, in some embodiments, are made from a hard material that transmits needed torque but allows a slight radial movement of the abrasive disc. Hub 300 also includes a shaft receiving bore 308 for coupling to a tool shaft.

Within an interior of housing 300 are a plurality of damping features 310, each of which comprise geometric designs. Damping features 310, as illustrated in FIG. 3A, are spaced equidistant about bore 308. However, in other embodiments, they may be spaced in other patterns. Additionally, while FIGS. 3A-3B illustrate an embodiment with five damping features 310, however it is expressly contemplated that, in some embodiments only 2 damping features 310 are present, or only 3 damping features 310, or only 4 damping features 310, or more than five damping features 310 are present, such as six damping features 310, or seven damping features 310, or eight damping features 310, or nine damping features 310, or ten damping features 310, or more. Hub 300 may also include centering features 312, which center the hub to the machine as well as to the abrasive wheel. FIG. 3D illustrates a close up view of a disconnect feature 310, with a gap that separates feature 310 from either portion of housing 302. Gaps 372 and 374 may have the same magnitude, or different magnitudes.

FIG. 3B illustrates an abrasive disc 350 attached to hub 300. FIG. 3C illustrates a cover 360 for an abrasive disc. Cover may have one or more pins 362, which, along with portions 352, may assist in transmitting torque in the embodiment illustrated in FIG. 3B. However, it is expressly contemplated that, in some embodiments, disconnecting features 304 and 306 are sufficient to transmit torque

Disconnecting features 304, 306 and 364 may be made of a softer material that allows some slight radial movement of the abrasive wheel 350 while still transmitting the needed torque. For example, a rubber, a polyurethane, a sorbothane™, or a silicone or another suitably soft material. For example, a typical difference between a hub housing material and a disconnecting feature may be a difference in elastic deformation. A disconnect feature 304, 306 may be up to 10×, 100× or even 1000× more elastically deformable than a material of hub housing 302. Illustrated in FIG. 3A and 3C is a round shape, however other shapes and relative positions are also expressly contemplated. Additionally, disconnection may also be achieved by one or more gaps 372, 374 , which may optionally allow even more movement of damping features 310.

Damping features 310 are made of a material that absorbs energy, and may include: standard soft polymer-like softer materials, soft polyurethane, sorbothane™ or similar material. First, the combination of the shape of damping feature 310. Second, the material selected. In some embodiments, the combination results in a damping feature with a storage modulus that is at least 100 times lower than pure material, and may be at least 1000 times lower than pure material, or at least 10,000 times lower than pure material, or even 100,000 times lower than pure material, or even 1,000,000 times lower than pure material.

In general, housing 302 is considered a structural feature, made from a structural material, while disconnect features 304, 306 are considered damping materials. Generally, structural materials has an elastic modulus >1 GPa, damping materials used for disconnect features will have moduli significantly smaller than the structural material.

Alternatively, or additionally, a combination of materials is selected, as described in greater detail below, either in addition to, or instead of a rubber-like material. Centering features 308, in one embodiment, are placed such that they align with a diameter of a steel centering portion on a machine that connects to, and drives rotation of, hub 300. The inner diameter of a grinding wheel may also be centered using connecting features positioned at centering features 312. Illustrated in FIG. 3A are 5 centering features 312, however there may be more or fewer. For example, it is expressly contemplated that only a subset of damping features 310 are used as connecting features. Connecting features 312 operate by receiving a rod which, in some embodiments, have a diameter which is 0.1 mm greater than the highest manufacturing tolerance of the inner diameter. Therefore, during the mounting, in some embodiments, the rods are slightly pressed to the hub center and be centered. During rotation of wheel 350, the mass of the rods will press the inner diameter of wheel 350 and keep it into its position.

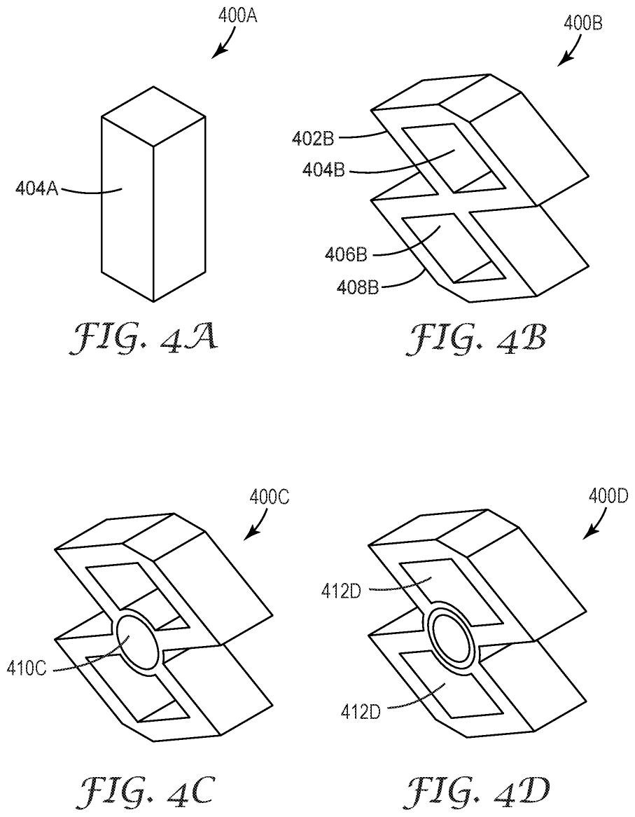

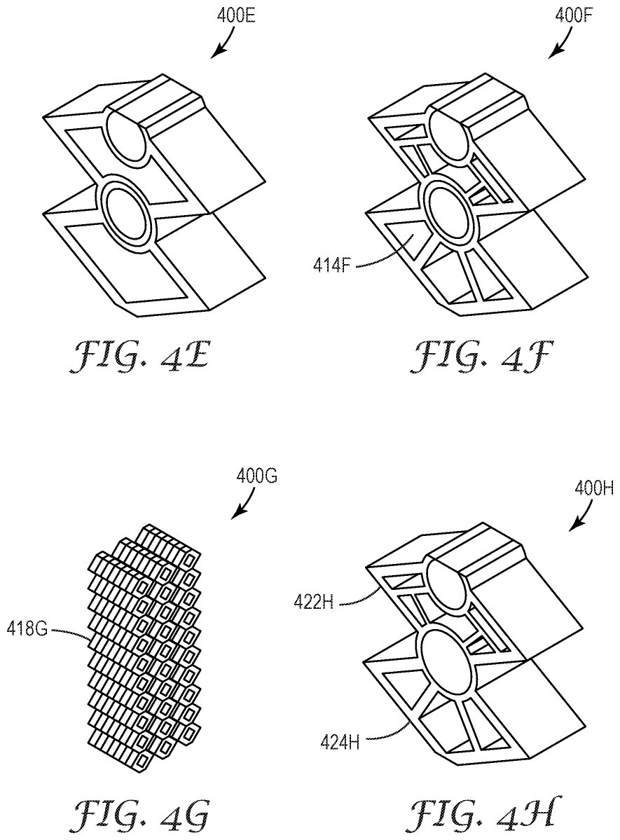

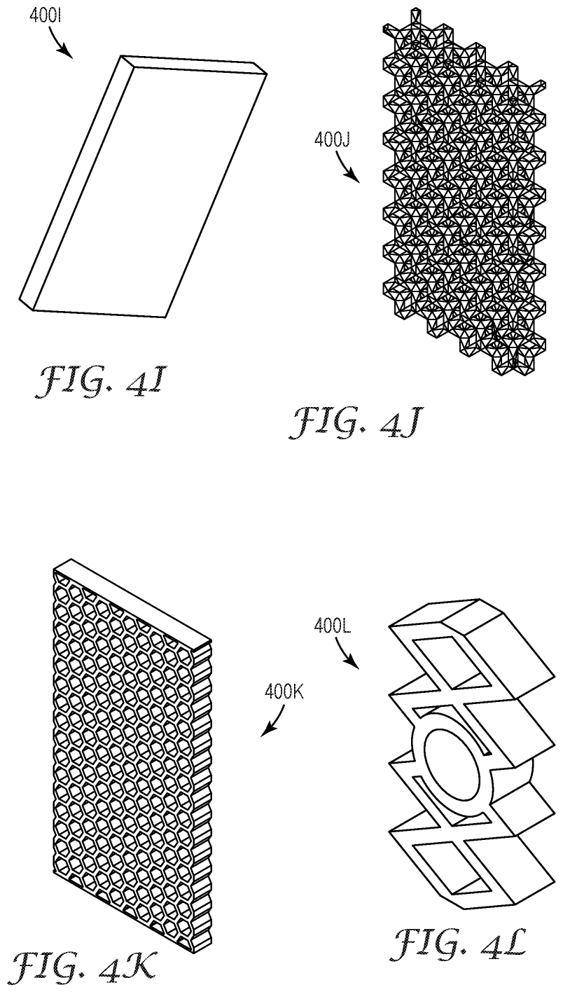

Damping features 310 illustrated in FIG. 3A may be adaptable to different wheel configurations or different abrading operations. In some embodiments, damping features 310 are 3D printed from a material strong enough to support stresses generated during wheel rotation . For example, damping features may be formed of polyamide-12. One or more dense rods are introduced in two dedicated places and are essential to absorb the energy and reduce the vibration acceleration level generated by the unbalanced abrasive wheel 350. The dense rods may be of any suitable high density material, including tungsten, tungsten carbide, nickel alloy, or steel. In some embodiments, the denser materials are placed in each center rhombus illustrated in FIG. 3A. However, rubber-like material may, in other embodiments, be a filler material for the center rhombus, in the rhombus spacing, or in the space around the rhombus structure. Different geometries/material and combination of them could be similarly used and are discussed in greater detail in FIG. 4 and in the Examples below. As used herein, “rubber-like” material refers to a broad class of material properties including flexibility, compressibility and vibration damping. Rubber-like materials may include natural and synthetic rubber as well as other suitable polymeric materials with similar properties.

FIGS. 4A-4L illustrate different damping structures that may be used in embodiments herein. Damping structures illustrated herein may be placed in a repeatable pattern about a center bore of the hub, or may be placed in other configurations, for example asymmetrically, within the hub structure. The performance of damping structures 400A-400H are discussed in greater detail in the Examples below. Different portions of damping structures may be formed of different materials. For example, polyamide-12, aluminum, steel, tungsten, rubber, resin, or other suitable materials may be used for both structural integrity and damping effects. Additionally, as illustrated in FIGS. 4A-4L, each damping structure may include several different portions, each of which may be formed of different materials which are then connected, for example by adhesive, welding, brazing, soldering, or another suitable fastening mechanism.

FIG. 4A illustrates a damping structure 400A. FIG. 4B illustrates a damping structure 400B that includes a rectangular prism 402B coupled to a first polygonal section 404B, coupled to a second polygonal section 408B,. As illustrated in FIG. 4B, both polygonal sections 404B, 408B have a hollow section 406B extending completely from a first side to a second side. In the embodiment of FIG. 4B, the polygonal sections 404B, 408B are rhomboid shaped, as are the hollow sections 406B. However, it is expressly contemplated that other shapes may are envisioned, including rectangles, square, kites, circles, triangles, pentagons, hexagons, septagons, octagons, nonagons, etc. Additionally, irregular shapes are also expressly considered, such as crescents, stars, arcs, crosses, or other shapes, or other suitable shapes. Additionally, the thickness of damping structures illustrated herein may also vary along either a length of a shape, a width of a shape, or both.

FIG. 4C illustrates another embodiment of a damping structure 400C where a stiffening rod 410C is inserted at the connection point between two polygonal components. In one embodiment, the stiffening rod 410C is a made of a hard metal, such as tungsten or steel. Stiffening rod is illustrated as cylindrical in FIG. 4C, however other cross-sectional shapes are also considered.

FIG. 4D illustrates another embodiment of a damping structure 400D where the internal area within the polygonal components are filled with a material 412D different from the polygonal component. Material 412D may be stiffer than the material forming the polygonal components, in some embodiments, or it may be more compressible, in other embodiments.

FIG. 4E illustrates another embodiment of a damping structure 400E in which a second rod 414E has been added, such that one polygonal element has a rod on opposing corners.

FIG. 4F illustrates another embodiment in which polygonal components are only partially filled with internal structures, at least some of which extend from a corner of a polygonal structure to an opposing side from the corner. However, while FIG. 4F illustrates one embodiment of internal structure 414F, others are expressly contemplated. Internal structure 414F may provide increased stability to damping structure 400F. In some embodiments, internal structure 414F is integral with polygonal components, for example made simultaneously using a molding or additive manufacturing process. Structure 414F may also be manufactured separately and inserted into the polygonal structure. Additionally, damping feature 400F also includes a structure 416F that intersects with one of the polygonal structures. Internal structure 414F may not be regular, and may adjust the movement around the rods, and therefore dissipating energy coming from vibration.

FIG. 4G illustrates a damping feature 400G with a textured surface 418G. While a rectangular prism is illustrated with textured surface 418G, other polygonal structures may also have textured surfaces. A simple shape is illustrated in FIG. 4G, and used for vibration analysis due to computer limitation, however it is expressly contemplated that the structure may be repeated multiple times. Feature 400G allows for a lot of small displacement which may dissipate more energy than a single bigger displacement. It provides a trend of the other units like reinforced cross module, rhombic dodecahedron module, dodecahedron modules described below.

FIG. 4H illustrates a damping feature 400H that includes different internal structures 422H and 424H in each of the polygonal structures.

FIGS. 4A-4H illustrate damping features 400A-400H that include polygonal features that, as illustrated in FIG. 3A for example, extend from a shaft-receiving ring 308. However, while FIGS. 4A-4H illustrate damping features with either a single or a pair of polygonal features, it is expressly contemplated that, in other embodiments, three or more polygonal features are connected. Additionally, while FIGS. 4A-4H illustrate embodiments where polygonal structures in a damping feature are the same, it is expressly contemplated that polygonal structures may differ within a damping feature depending on the needs of a given abrasive operation.

FIGS. 41-4L illustrate damping patterns 4501-450L that, instead of operating separately, may form the basis of a damping layer within a reusable hub, instead of, or in addition to individual damping components. Pattern 4501 is a rectangular prism shape which may extend from a central bore, from an external edge, or may be positioned elsewhere within the reusable hub housing.

FIG. 4J illustrates a pattern 450J which includes a repeating lattice structure. The lattice structure may be made of one or more materials.

FIGS. 4K and 4L illustrate patterns 450K and 450L which may be used as single dampening features or may be incorporated into a larger repeating pattern.

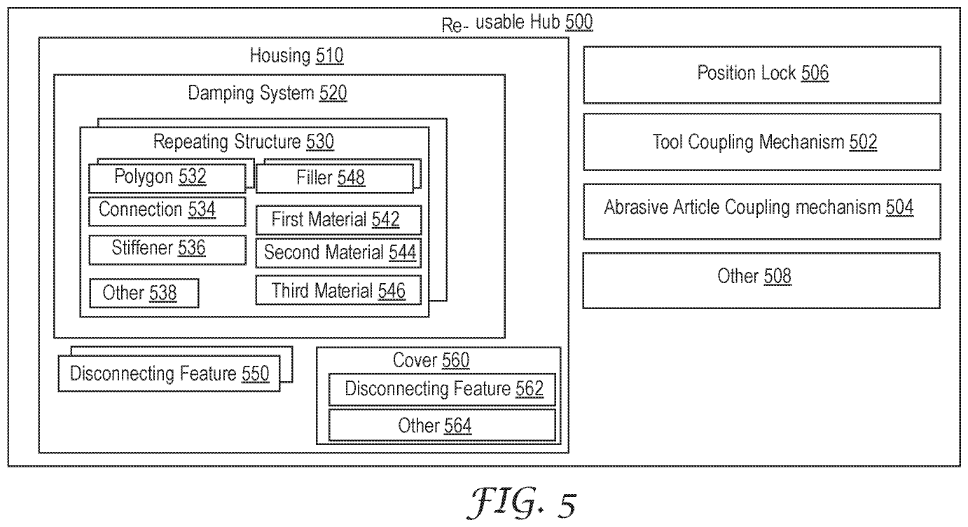

FIG. 5 illustrates a block diagram illustrating components of a reusable hub in accordance with embodiments herein. Reusable hub 500 may be designed to operate with a wide variety of abrasive articles including bonded or nonwoven articles, and including abrasive wheels of a variety of shapes including depressed center grinding wheels, Cut off wheels (COW), Cut-and-Grind wheel (C&G wheel), Flex-wheel, Cylindrical grinding wheels (ID/OD/Centerless grinding wheels), Cam/Crank grinding wheels, surface grinding wheels, or gear grinding wheels (single rib, threaded, bevel gear grinding wheels), plunge grinding, edge grinding, finishing grinding wheels, super-finishing grinding wheels, polishing grinding wheels, Creep-feed grinding wheel, tool and or cutter grinding wheels..

Reusable hub 500 includes a housing 510 for a damping system 520. Reusable hub also includes a position lock 506, which may lock a relative position of hub 500 with respect to a tool and/or to an abrasive article. Hub 500 also has a coupling mechanism 502 for removably coupling to a tool that drives rotation of hub 500 and an attached abrasive article. Hub 500 also has a coupling mechanism 504 for coupling to an abrasive article. Coupling mechanisms 502, 504 may include threading, a mating ring, or another suitable removable coupling mechanism. Reusable hub 500 may have other features 508.

Reusable hub housing 510 includes a damping system 520 and a disconnecting feature 550 which separates an abrasive wheel attached to hub 500 from a machine shaft. Disconnecting feature 550 may run parallel to an edge of hub housing 510.

In some embodiments, hub housing 510 includes two components, a component including the damping system 520 and a cover 560. In such embodiments, cover 560 may include a disconnecting feature 562 that is separate from disconnecting feature 550. Disconnecting features 550, 562 may interact, in some embodiments. Cover 560 may include other features 564, such as connecting features to connect to a component including damping system 520.

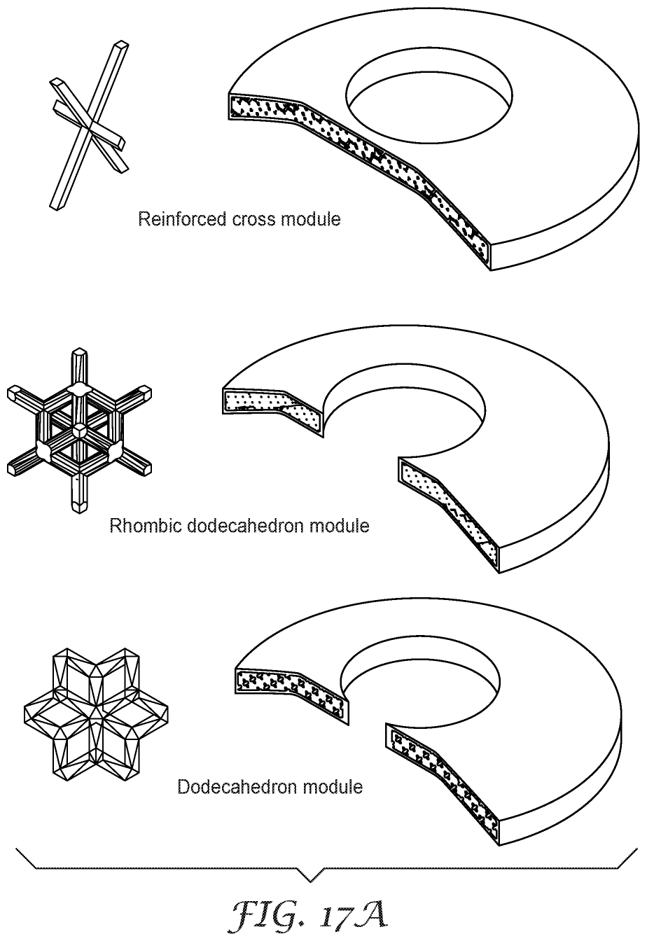

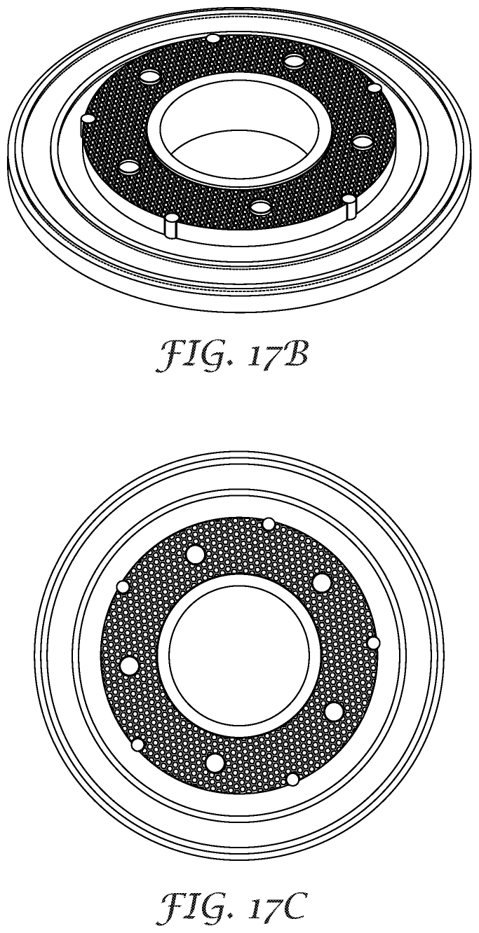

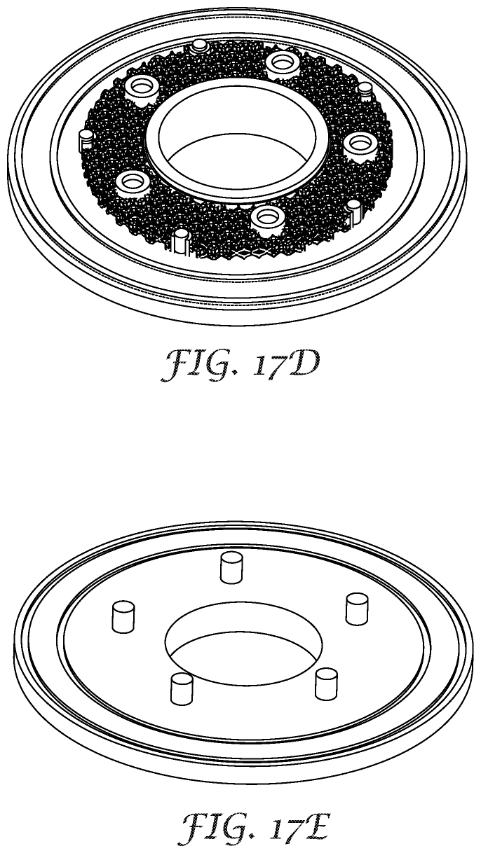

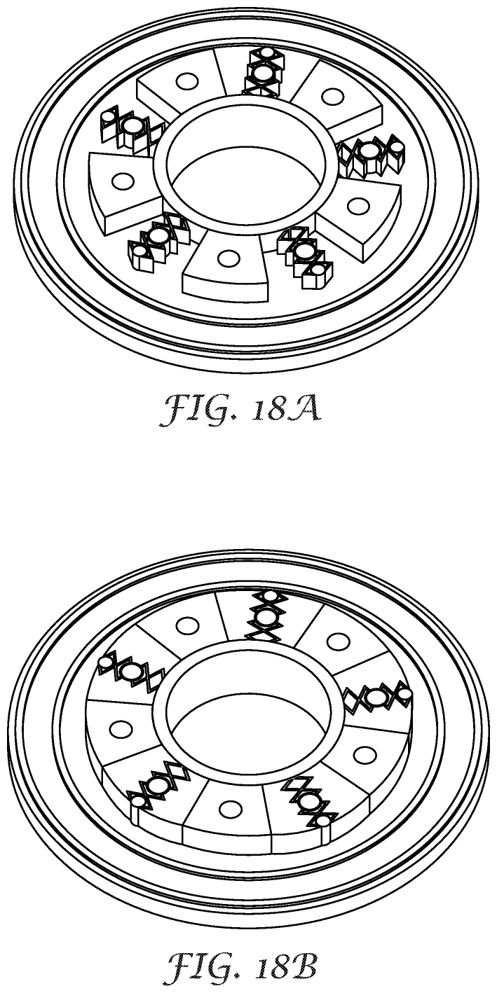

Damping system 520 includes a plurality of repeating structures 530. Repeating structures may be discreet, as illustrated in FIGS. 4A-4H, or may repeat across a damping surface within housing 510, as illustrated in FIGS. 17-18.

Repeating structure 530, in some embodiments, includes one or more polygonal structures 532 which are connected to a portion of housing 510 by a connector 534. Connector 534, in one embodiment, refers to a connection to a ring on a hub about a bore-receiving point. However, in other embodiments, damping system 520 includes connectors 534 that connect repeating structures 530 to each other, or to another portion of housing 510.

Polygonal structures 532 may couple to each other by being integrally formed, for example by an additive manufacturing or molding process. In other embodiments, polygonal structures 532 are connected by a fastener, such as an adhesive, welding, brazing, or other method.

Repeating structure 530 may include one or mor stiffener elements 536. Stiffener element 536 may be formed of a different material than polygons 532 and/or connector 534, in some embodiments. Stiffener element 536 may be placed at a connection point between polygonal structures 532, at or instead of connector 534, or at another point. In embodiments where stiffener element 536 is a different material from polygon 532, it may also be placed to adjust a weight distribution across the hub 500.

Polygonal structures 532 may have a hollow portion that extends partially or completely from a first face to a second face. The hollow portion may be the same or a different shape than polygonal structure 532. Embodiments that have a hollow portion may have a filler 548 that either fills the entire hollow structure, or only part of the structure. For example, filler 548 may be connecting structures that extend from a first corner or edge of a polygonal structure 532 to a second corner or edge of the structure.

Repeating structure 530 may have other features 538, include textured surfaces such as wavy, rough or indented.

Repeating structure 530 may be made of a first material 542 and, in some embodiments, a combination of the first material 542 and a second material 544 and, in some embodiments a combination of the first material 542, second material 544, and a third material 546. The first 542, second 544 and third materials 546 may be: steel, tungsten, or aluminum for stiffness, polyamide-12 or rubber for flexibility, or resin composite.

Structural materials may include metals and metal alloys such as aluminum, high carbon steels, stainless steels, high nickel alloys, and titanium; engineering plastics e.g. epoxies, polyamides, polycarbonates, acrylonitrile butadiene styrene, polyethylene terephthalate, polystyrene, polytetrafluorethylene, polyvinylidene fluoride, polymethyl methacrylate, phenolic resins, vinyl ester resins, and polyetherketones; and fiber reinforced plastics consisting of, for example, the above mentioned resins reinforced with or more of: glass fiber, carbon fiber, ceramic fiber, polyamide fiber. Other suitable structural materials are also envisioned.

The damping material is typically an elastic and/or rubber material with elastic modulus at least 10× below that of the structural material. Possible damping materials may include: natural rubber (polyisoprene), polychloroprene, silicone rubbers, nitrile rubber, polyisoprene, polyethylene, fluoroelastomers, styrene-butadiene rubber, polyolefins, polyolefin copolymers, polyurethanes or other suitable elastic materials.

Structural or damping materials may also include sustainable materials. Sustainable materials may include recyclable materials, such as plastics, metals or other materials that can be recaptured and recycled. Additionally, some embodiments herein include reusable hubs with one or more substainable polymer components, such as bio-based or degradeable polymers or mixtures of polymers. Such materials may be preferred in some embodiments as the polymer mixtures may provide tuneable properties, as described in U.S. Provisional Patent Application with Ser. No. 63/074617, filed on Sep. 4, 2020.

An additional class of fillers may include particulate forms of any of the above, as well as ceramic and/or inorganic particles including alumina, calcium carbonate, magnesium carbonate silica, aluminosilicates, silicon carbide, iron oxides, and naturally occurring minerals.

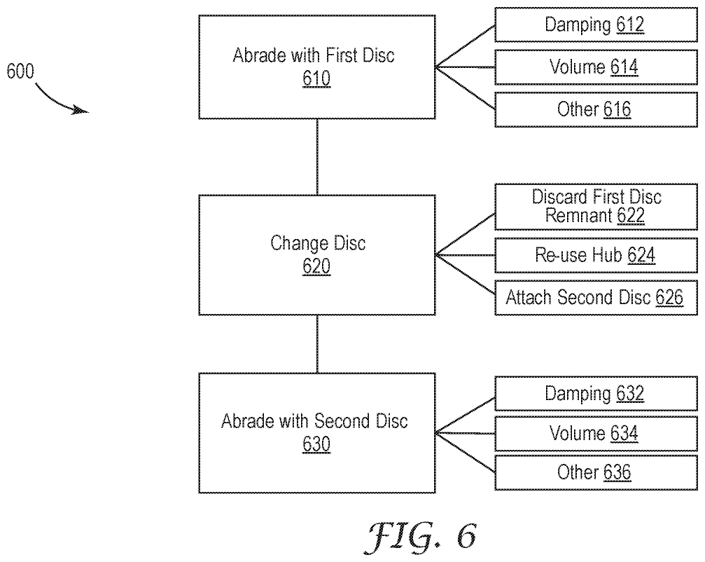

FIG. 6 illustrates a method of using a reusable hub in accordance with embodiments herein. Method 600 may be useful for a reusable hub engaging with any number of suitable abrasive wheel designs, including depressed center grinding wheels, Cut off wheels (COW), Cut-and-Grind wheel (C&G wheel), Flex-wheel, Cylindrical grinding wheels (ID/OD/Centerless grinding wheels), Cam/Crank grinding wheels, surface grinding wheels, or gear grinding wheels (single rib, threaded, bevel gear grinding wheels), plunge grinding, edge grinding, finishing grinding wheels, super-finishing grinding wheels, polishing grinding wheels.

In block 610, a first disc is used with the reusable hub. The reusable hub may provide vibrational damping, as indicated in block 612. The reusable hub may also allow substantially all of the abrasive wheel volume to be used, as indicated in block 614. For example, up to 90% of the wheel volume, as compared to only 70% of the wheel volume in the case of hubbed depressed center grinding wheels. The reusable hub may also have other features, as indicated in block 616, such as a locking feature to maintain a relative position with the abrasive wheel.

In block 620, the first disc is changed out for a second disc. The first disc may be changed out when insufficient abrasive article volume is left for an abrading operation to continue. The hub is removed from the first disc and re-used with the second disc, as indicated in block 624. This may involve unlocking a locking feature, unscrewing a threaded connection between the hub and the abrasive article, or otherwise removing the hub. It may also include discarding a mounting ring or flange used in the first abrading operation and retrieving a new mounting ring for use with the second disc. The second disc is then attached to the reusable hub, for example using threading, a locking feature, or other suitable temporary or semi-permanent attachment mechanism.

In block 630, the second disc is used with the reusable hub. The reusable hub may provide vibrational damping, as indicated in block 632, and may allow for substantially all of the abrasive wheel volume to be used, as indicated in block 634. The hub may also provide other features, as indicated in block 636.

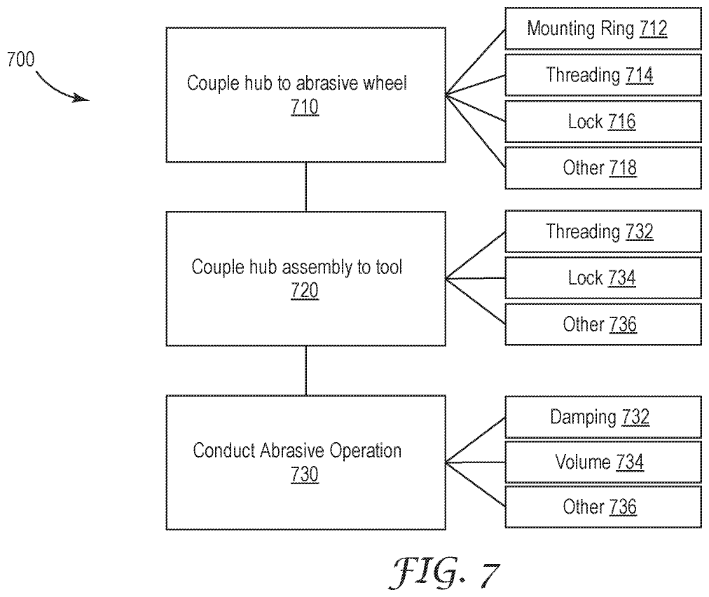

FIG. 7 illustrates a method of abrading a workpiece in accordance with embodiments herein. Method 700 may be useful with any suitable abrasive wheel, including but not limited to: depressed center grinding wheels, Cut off wheels (COW), Cut-and-Grind wheel (C&G wheel), Flex-wheel, Cylindrical grinding wheels (ID/OD/Centerless grinding wheels), Cam/Crank grinding wheels, surface grinding wheels, or gear grinding wheels (single rib, threaded, bevel gear grinding wheels), plunge grinding, edge grinding, finishing grinding wheels, super-finishing grinding wheels, polishing grinding wheels. In block 710, a reusable hub is removeably coupled to an abrasive wheel. The coupling may include a mounting ring 712, threading 714 between the hub and the abrasive wheel, or between the hub and the mounting ring, a locking feature 716 that maintains a relative position between the hub and the abrasive wheel, or another suitable non-permanent connection feature. The connection between a reusable hub and an abrasive wheel is a mechanical connection, and not a chemical connection, in some embodiments. Additionally, in some embodiments the connection is an adhesive-free connection.

In block 720, the reusable hub is removeably coupled to a tool that causes rotation of the hub and associated abrasive wheel. The hub may have an internal bore with threading 732, for example, which may facilitate the removeable connection. The hub may also have a locking feature 734, to maintain a relative position of the hub and the tool. Other connection features may also be present, as indicated in block 736.

In block 730, an abrasive operation is conducted by contacting the abrasive wheel to a work surface and actuating rotation. The reusable hub may provide vibrational damping, as indicated in block 732. The reusable hub may also be sized such that at least about 90% of the abrasive article is available for abrading, as indicated in block 734.

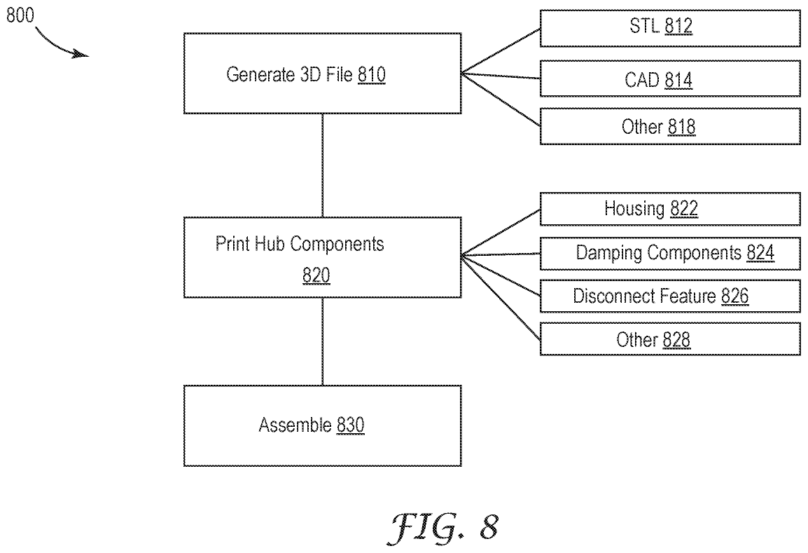

FIG. 8 illustrates a method of manufacturing a reusable hub using a 3D printer, which may be applicable for some embodiments herein. However, while a method of additive manufacturing is illustrated, it is expressly contemplated that other manufacturing methods may be used, including molding.

In block 810, an 3D file is generated for the re-useable hub components and provided to a 3D printer. Some or all of the components may be made from additive manufacturing. The file may be an STL file 812, CAD file 814, or another suitable file format 818, depending on a preferred printer format.

In block 820, hub components are printed using additive manufacturing. For example, a housing 822 or components of a housing 822 may be additively manufactured, in some embodiments. Alternatively, or in addition, one or more damping components 824 may be additively manufactured, in some embodiments. Alternatively, or in addition, a disconnect feature 826 may be additively manufactured, in some embodiments. Other components or features 828 may also be additively manufactured, in some embodiments.

In block 830, a hub is assembled. In some embodiments, the hub includes some components that are not additively manufactured, which are compiled with any components that are additively manufactured. The assembled hub may reusably connect an abrasive article to a grinding tool. For example, stiffener rods or other shapes have may be added to an additively printed component. Similarly, the rubber-like material which may be fixed in placed or may be filled, for example by injection, molding or other method, as liquid or paste phase and cured in a second step.

The above-presented description and figures are intended by way of example only and are not intended to limit the illustrative embodiments in any way except as set forth in the appended claims. It is noted that various technical aspects of the various elements of the various exemplary embodiments that have been described above can be combined in numerous other ways, all of which are considered to be within the scope of the disclosure.

Accordingly, although exemplary embodiments have been disclosed for illustrative purposes, those skilled in the art will appreciate that various modifications, additions, and substitutions are possible. Therefore, the disclosure is not limited to the above-described embodiments but may be modified within the scope of appended claims, along with their full scope of equivalents.

A method providing damping during an abrading operation is provided. The method includes removably coupling the abrasive wheel to a hub. The abrasive wheel has an outer circumference and an inner circumference. A layer of abrasive material extends between the inner and outer circumference. The method also includes abrading a worksurface by contacting the abrasive disc to the worksurface. The hub includes a housing and a plurality of damping units within the housing. The plurality of damping units are shaped to reduce vibrations during a grinding operation.

The method may be implemented such that the damping unit includes metal, plastic, ceramic, rubber, a polymer, resin, or fiber-reinforced composite.

The method may be implemented such that the plurality of damping units are discrete and separately positioned about a bore receiving ring within the housing.

The method may be implemented such that the plurality of damping units are coupled together and fonn a single structure within the housing.

The method may be implemented such that one of the plurality of damping units includes a polygonal structure.

The method may be implemented such that the polygonal structure is a first polygonal structure. The one of the plurality of damping units includes a second polygonal structure.

The method may be implemented such that the first polygonal structure has an aperture extending from a first face to a second face.

The method may be implemented such that the aperture is filled with a second material. The first polygonal structure includes a first material. The first material is different from the second material.

The method may be implemented such that the one of the plurality of damping units includes a stiffener.

The method may be implemented such that the hub includes a disconnecting feature.

The method may be implemented such that the hub includes a cover.

The method may be implemented such that the first material has a first storage modulus, the second material has a second storage modulus. The second storage modulus is less than the first storage modulus.

The method may be implemented such that the second storage modulus at least 10 times less than the first storage modulus.

The method may be implemented such that the first material has a first damping factor, the second material has a second damping factor. The second damping factor is greater than the first damping factor.

The method may be implemented such that the abrasive wheel is removably coupled to the hub.

The method may be implemented such that coupling the abrasive wheel to the hub includes threading.

The method may be implemented such that coupling the abrasive wheel to a hub includes coupling the hub to a mounting ring that couples directly to the abrasive wheel.

The method may be implemented such that the hub includes a first portion and a second portion. Coupling includes coupling the first portion to the second portion such that the abrasive wheel is in between the first and second portions.

The method may be implemented such that the abrasive wheel is a depressed center grinding wheel, a Cut off wheel, a Cut-and-Grind wheel, a Flex-wheel, an inner-diameter grinding wheel, an outer-diameter grinding wheel, a centerless grinding wheel, a Cam/Crank grinding wheel, a surface grinding wheel, a gear grinding wheel, a plunge grinding wheel, an edge grinding wheel, a finishing grinding wheel, a super-finishing grinding wheel, or a polishing grinding wheel.

An abrading system is presented that includes an abrasive wheel including abrasive particles within a binder matrix. The abrasive wheel includes an outer circumference, an inner circumference, and a wheel width that extends from the outer circumference to the inner circumference. The system includes a hub that has a housing that couples to the abrasive wheel, a bore that receives a tool, and a plurality of damping features within the housing, each of the plurality of damping features being shaped to reduce vibrations caused by the abrasive wheel contacting a worksurface.

The system may be implemented such that the hub includes an upper portion and a lower portion. The upper portion includes a cover that connects to the lower portion using fasteners. The damping features are independent of the fasteners.

The system may be implemented such that the hub further includes a disconnect feature that separates an abrasive wheel from the tool.

The system may be implemented such that the disconnect feature is within the housing and is parallel to the outer circumference.

The system may be implemented such that the hub housing includes a first material, and the first material includes metal, plastic, or fiber-reinforced composite.

The system may be implemented such that the plurality of damping features each include a second material different from the first material.

The system may be implemented such that each of the plurality of damping features include a polygonal structure.

The system may be implemented such that the polygonal structure is a first polygonal structure. Each of the plurality of damping features include a second polygonal structure coupled to the first polygonal structure.

The system may be implemented such that it also includes a stiffener coupled to the first and second polygonal structures.

The system may be implemented such that the polygonal structure includes an aperture.

The system may be implemented such that the aperture includes a filler material. The filler material differs from a polygonal structure material forming the polygonal structure.

The system may be implemented such that the aperture extends completely from a first face of the polygonal structure to a second face of the polygonal structure.

The system may be implemented such that the aperture includes an aperture perimeter that is substantially parallel to a polygon perimeter of the polygonal structure.

The system may be implemented such that the plurality of damping features include discrete damping features positioned about the bore.

The system may be implemented such that the plurality of damping features are coupled and form a damping structure within the housing.

The system may be implemented such that the polygonal structure includes a rhombus, a circle, an ellipse, a triangle, a quadrilateral, a pentagon, a hexagon, a septagon, an octagon, a nonagon, a star, or a crescent.

The system may be implemented such that it also includes a locking mechanism that fixes a relative position of the hub to the abrasive wheel.

The system may be implemented such that the abrasive wheel is a depressed center grinding wheel, a Cut off wheel, a Cut-and-Grind wheel, a Flex-wheel, an inner-diameter grinding wheel, an outer-diameter grinding wheel, a centerless grinding wheel, a Cam/Crank grinding wheel, a surface grinding wheel, a gear grinding wheel, a plunge grinding wheel, an edge grinding wheel, a finishing grinding wheel, a super-finishing grinding wheel, or a polishing grinding wheel.

The system may be implemented such that the plurality of damping features are spaced apart from a housing of the hub.

A hub for an abrasive article includes a housing configured to couple the hub to the abrasive article, on an exterior edge of the hub, and to a machine shaft, on an interior edge of the hub. The hub also includes a vibrational damping system within the housing. The system includes a plurality of damping units, each having a structure shaped to reduce vibrations. Each of the plurality of damping units are positioned within the housing.

The hub may be implemented such that the hub includes metal, plastic or fiber-reinforced composite.

The hub may be implemented such that the hub releasably couples to the abrasive article.

The hub may be implemented such that the hub releasably couples to the machine shaft.

The hub may be implemented such that the structure includes a first polygonal structure.

The hub may be implemented such that the structure includes a second polygonal structure.

The hub may be implemented such that the second polygonal structure is integrally formed with the first polygonal structure.

The hub may be implemented such that the structure further includes a stiffener. The stiffener includes a stiff material that differs from a structure material forming the structure.

The hub may be implemented such that the first polygonal structure includes an aperture.

The hub may be implemented such that the aperture extends from a first face of the first polygonal structure to a second face of the polygonal structure. The first and second faces are parallel to each other and to the housing.

The hub may be implemented such that the aperture includes an aperture perimeter that is substantially parallel to a first polygonal structure perimeter.

The hub may be implemented such that the aperture includes filler material. The filler material differs from a structure material forming the structure.

The hub may be implemented such that the plurality of damping units are discrete, such that a first damping unit is separate from a second damping unit.

The hub may be implemented such that each of the first and second damping units are coupled to the interior edge of the hub.

The hub may be implemented such that the plurality of damping units are interconnected.

The hub may be implemented such that it also includes a disconnect feature configured to separate the abrasive article from the machine shaft.

The hub may be implemented such that the disconnect feature is a first disconnect feature, and further including a second disconnect feature.

The hub may be implemented such that the housing includes a main housing and a cover that couples to the main housing. The cover includes the second disconnect feature.

The hub may be implemented such that the disconnect feature is parallel to an edge of an abrasive article.

A damping system for an abrasive article hub is presented that includes a plurality of damping units, each damping unit including a damping structure. The plurality of damping units are repeated in a pattern to form the damping system. The damping system is housed within the abrasive article hub.

The damping system may be implemented such that the damping structure includes a polygonal unit including a first material.

The damping system may be implemented such that the polygonal unit includes an aperture. The aperture is filled with a filler material different from the first material.

The damping system may be implemented such that the damping structure includes a stiffener coupled to the polygonal unit. The stiffener includes a stiffener material different from the first material.

The damping system may be implemented such that the polygonal unit is a first polygonal unit, and further including a second polygonal unit.

The damping system may be implemented such that the first and second polygonal units are integrally connected.

The damping system may be implemented such that the first material includespolyamide-12, a polymer, a resin, or a metal.

The damping system may be implemented such that the first material is a polymer, and the polymer is polyamide, aromatic polyester, epoxy based resin, phenolic based resin, imide, polyetherimide and polyimide, polyamideimide, aramid and polyaramid, polyetheretherketone, polyphenylene sulfide or a mixture thereof.

The damping system may be implemented such that the polymer is reinforced with a polymeric fiber, a glass fiber, a carbon fiber or a ceramic fiber.

The damping system may be implemented such that the first material is a metal, and the metal is aluminum, an aluminum-based alloy, copper, a copper-based alloy, a zinc-based alloy, a steel-based alloy, a carbon-based alloy, or a mixture thereof.

The damping system may be implemented such that the filler material includes silicon, rubber, polyurethane, polyethylene, polybutadiene, acrylic and polyacrylate, poly(ethyl methacrylate), copolyester, polyvinyl, epoxy, fluoroelastomer, polyether block amide, ethylene-vinyl acetate, sorbothane or mixture thereof.

The damping system may be implemented such that the filler is a continuous solid, a foam, or in the form of beads, either solid or hollow.

The damping system may be implemented such that the stiffener material includes tungsten, tungsten carbide, a nickel alloy, a lead alloy, bronze, steel or a mixture thereof

The damping system may be implemented such that it further includes a disconnect feature, separate from the plurality of damping units, housed within the abrasive article hub, the disconnect feature configured to separate an abrasive article from a machine shaft.

The damping system may be implemented such that the plurality of damping units are interconnected to form a damping structure within the abrasive article hub.

The damping system may be implemented such that the plurality of damping units are integrally formed.

### EXAMPLES

### Example 1

A representative geometry of a depressed center grinding wheel was selected for this model. The grinding wheel was a Cubitron II resin bonded cutting disk, obtained from 3M Company. The wheel had an OD of 125 mm, an ID of 22.25 mm, and a thickness of 4 mm. The main properties of the abrasive glass fiber reinforced resin bonded disk (used for FEM stress, displacement and vibration properties calculation) were:
Elastic modulus: 500 MPa
Poisson's ratio: 0.22
Mass density: 2000 kg/m³
Tensile strength: 40 MPa
Thelma expansion coef.: 2.10-05/K
Material damping ratio: 0.01

Imbalance is an important parameter generating vibration and user issue, a mass was introduced in the grinding wheel to simulate an imbalance. The mass was designed for generating a static displacement of the outer ring of 0.3 mm rotating at 10000 rpm which is a representative speed for such machines (even knowing that 125 mm wheels are rated up to 12,250 rpm). The mass has 2.8 g.

### Example 2

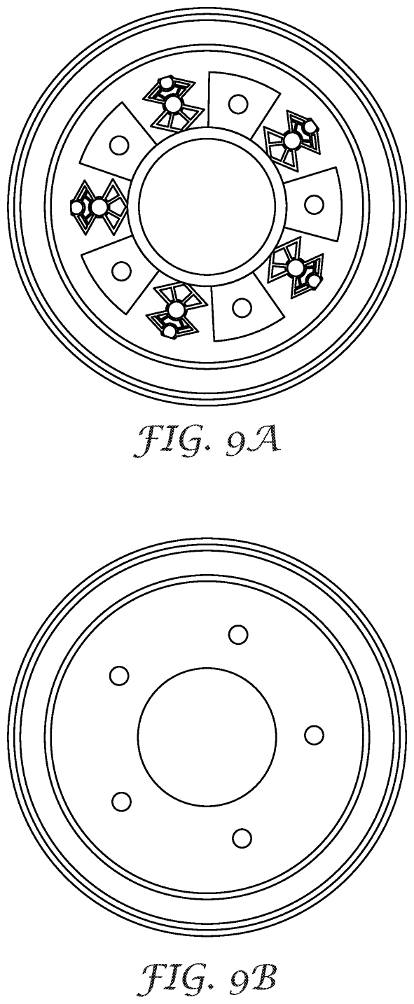

A reusable hub was printed from PA12, as illustrated in FIGS. 9A-9B. The hub had an OD of 65 mm, an ID of 24 mm, an ID cutting disk of 46 mm, and a thickness of 3 mm each side of the cutting disk.

The main properties of the PA12 material selected to be printed an EOS Formiga 110 printer were (used for FEM stress, displacement and vibration properties calculation), with the recommended parameter set for material PA2200, available from EOS Formiga:
Elastic modulus: 1200 MPa
Poisson's ratio: 0.40
Mass density: 930 kg/m³
Tensile strength: 33 MPa
Compressive strength: 62.5 MPa
Yield strength: 30 MPa
Material damping ratio: 0.05

### Example 3

Solidworks Premium 2018 was used for all studies using premium simulation add-in. The analysis was done different potential solution of single units. For each, a solid alu 6061 plate of 50 mm×50 mm×3 mm was placed at the bottom of the element. 2 sides were fixed and a probe (probe 1) was placed in the bottom center of the plate to analyze the acceleration and displacement following several initial conditions.

On top of the unit, a solid alu 6061 plate of 10 mm×10 mm×3 mm was placed to receive the external force (uniformly distributed) or vibration. Another probe was placed in the top center of this plate (probe2).

The height of the unit was kept all the time the same at 30 mm.

In order to define a reasonable external solicitation level, it was taking into account that, for a standard grinding wheel the displacement of the wheel during high vibration level is in the range of 0.2-0.3 mm.

Different investigations were done to define the appropriate external solicitation and a force of 100N was found generating a similar displacement on the 30 mm unit cell.
a) A static analysis was run each time to evaluate the level of von Mises stresses and displacement on probes 1 and 2. Depending on the study and the displacement generated by the 100N force, “Large displacement” and/or “soft spring” were used to stabilize the model. No thermal effect was taken into account.

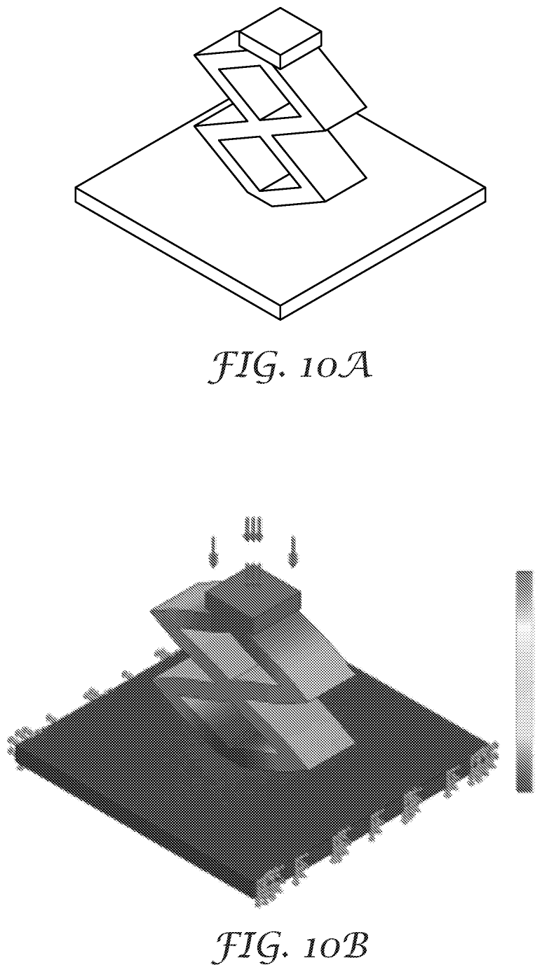

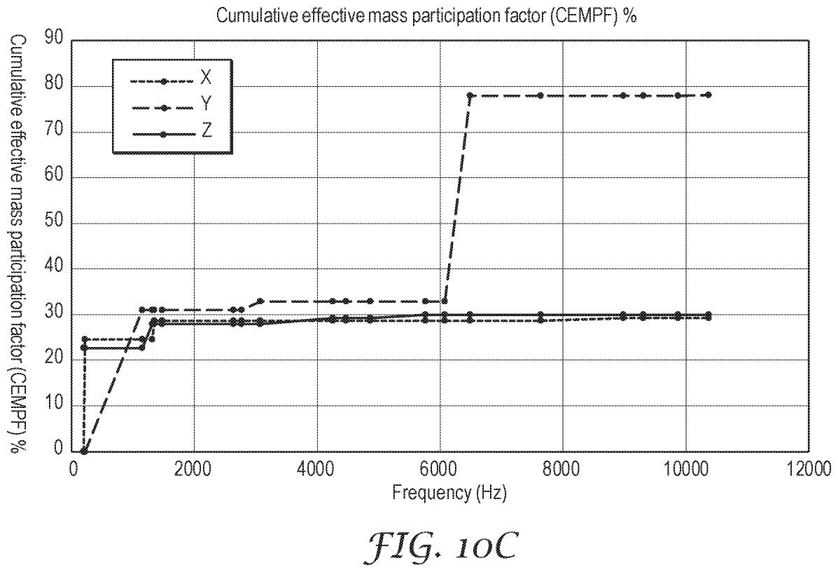

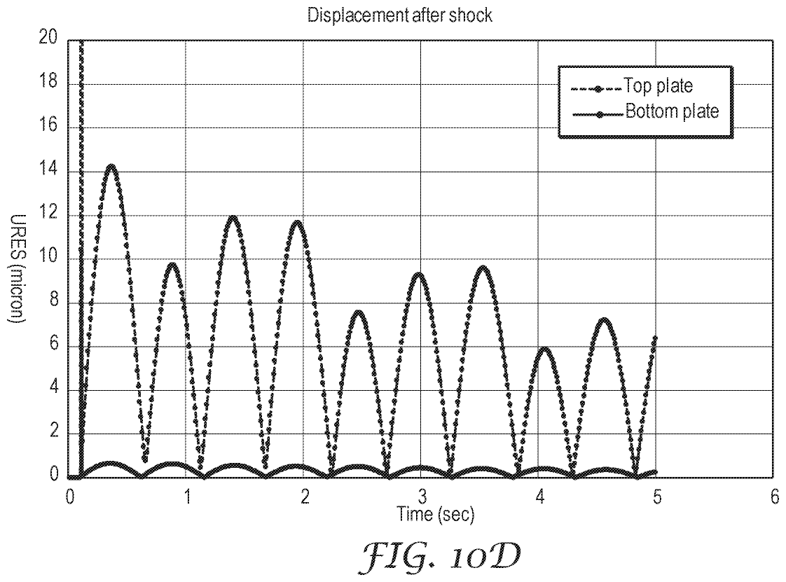

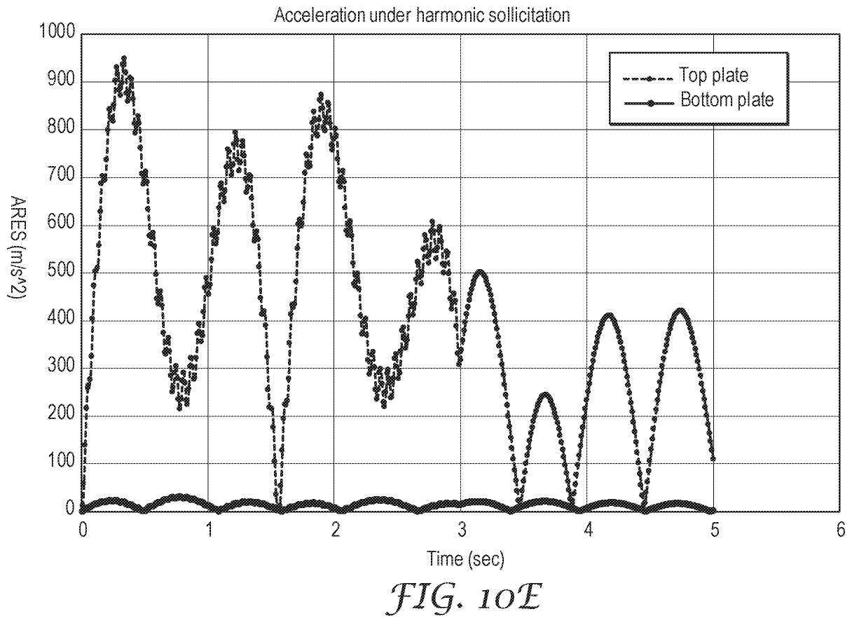

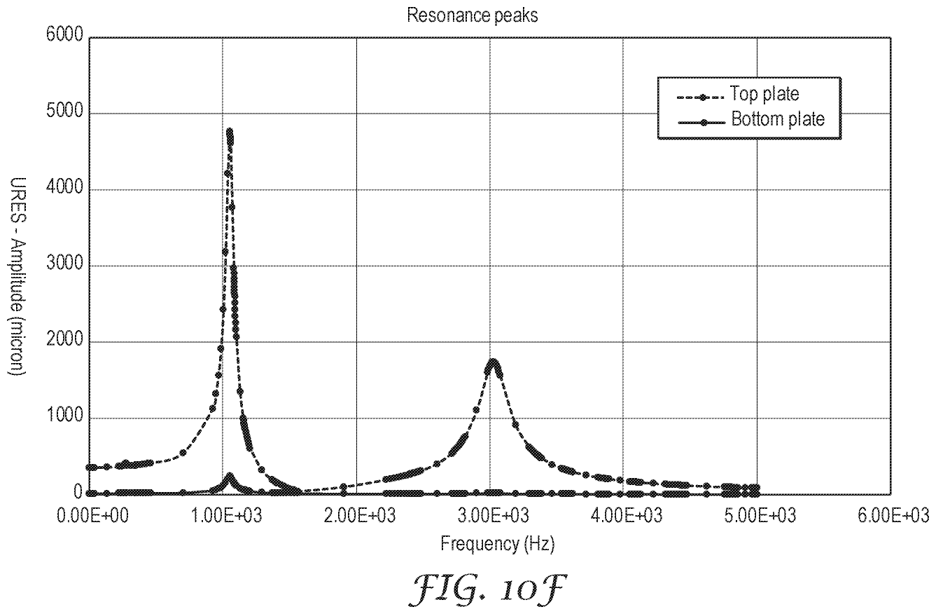

FIG. 10A illustrates the unit studied in Example 3, namely a PA12 double rhombus structure. FIG. 10B illustrate the static analysis of the unit illustrated in FIG. 10A.
b) The frequency analysis was conducted on the 20 first natural frequencies. It is usually said that 5 to 10 frequencies are enough to cover the main effects. Most probably due to the completely new shapes, it was discovered that 20 frequencies should be taken into account to cover a reasonable range of mass participation, at minimum in the direction of the external force (radial for the wheel/disk—Y direction for the studied units).

FIG. 10C illustrates mass participation on the 20 modal frequencies considered and FIG. 10D illustrates a system response against a shock applied.
c) In order to analyze the behavior of the different unit studied, a shock of 100N was applied during 0.01 s after 0.1 s and the analysis was done during a total of 5 s. The analysis was done considering the 20 first frequencies. The material damping properties were selected for each material used in the assembly.
d) Another linear dynamic analysis was done by applying the 100N force following a harmonic loading of 167 Hz (10000 rpm) for 3 seconds and then no external loading during 2 remaining seconds (total 5 s). Again, the analysis was done considering the 20 first frequencies. The material damping properties were selected for each material used in the assembly.

FIG. 10E illustrates the subsystem response when a harmonic load was applied during 3 s and the system was left free for 2 seconds. FIG. 10F illustrates an example resonance frequency analysis.
e) Finally, a harmonic linear dynamic analysis was conducted in order to determine at which frequency the resonance is expected and if a reasonable safety factor between the resonance frequency and the working speed range is existing.

### Example 4

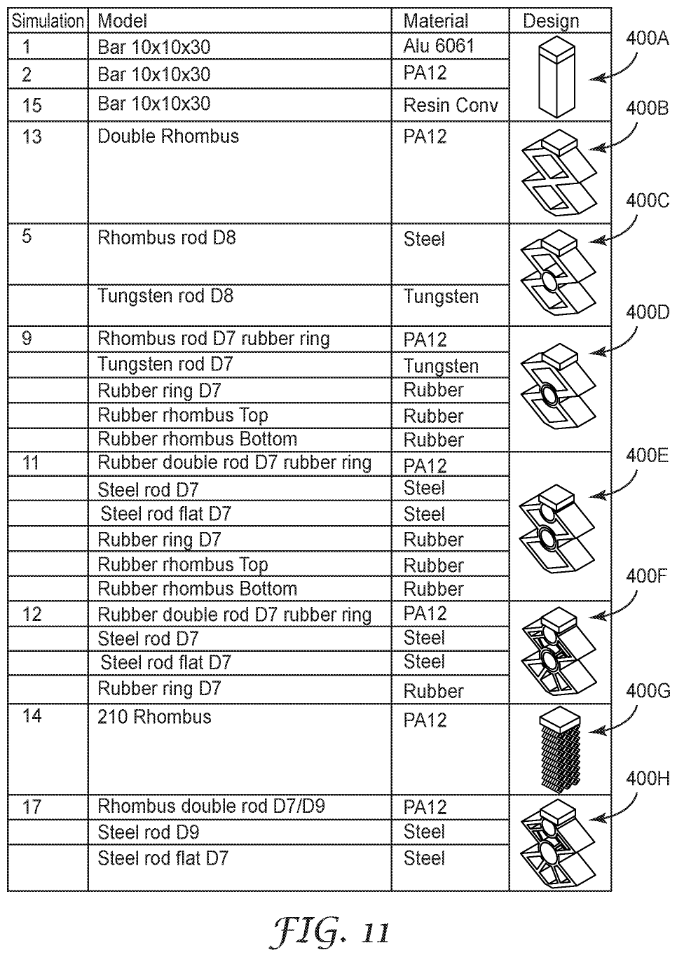

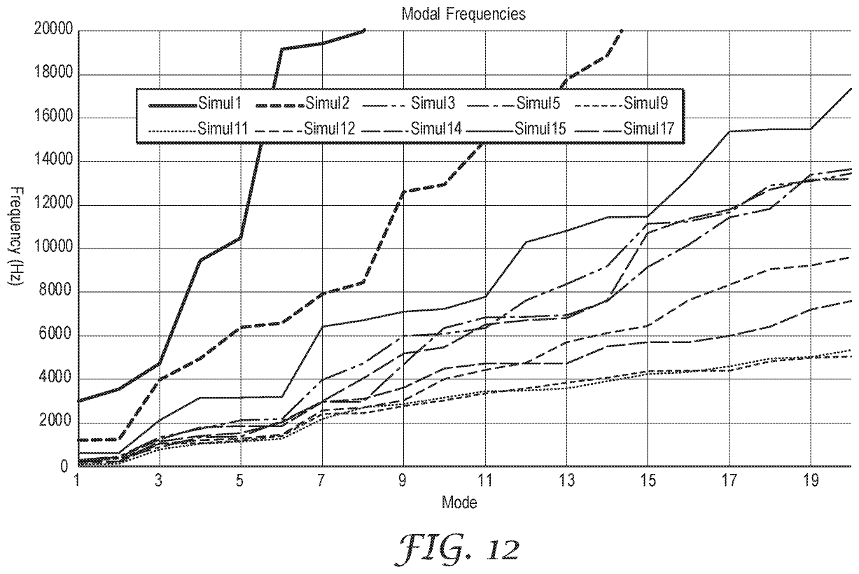

Different unit cells were studied in simulations according to the chart in FIG. 11. The results of the frequency analysis are illustrated in FIG. 12. It is noted that simulation 15 represents the actual resin bonded material.

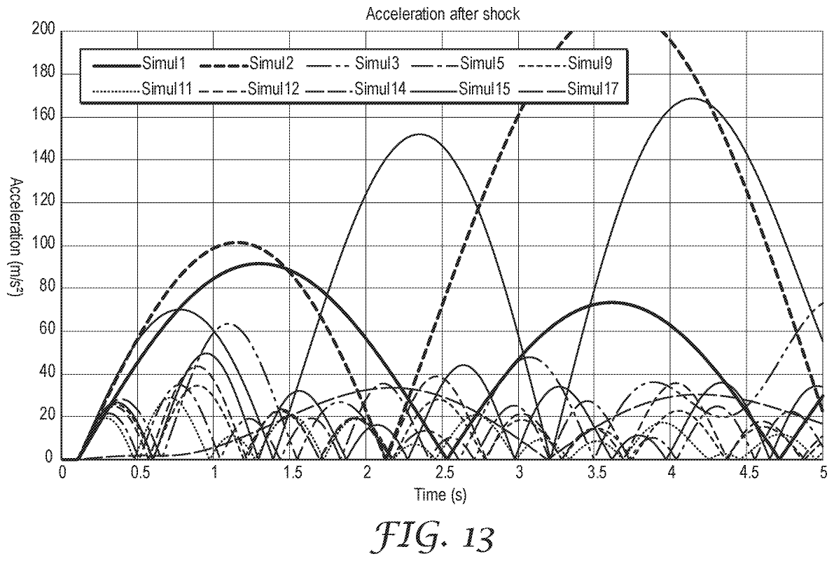

FIG. 13 illustrates Acceleration at the center of the bottom plate after having applied a shock of 100N during 0.01 s.

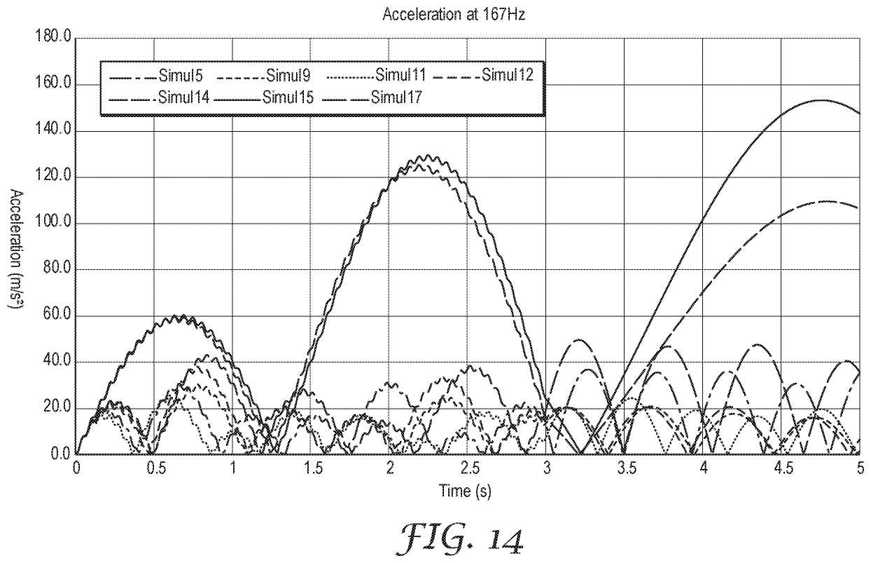

FIG. 14 illustrates Acceleration at the center of the bottom plate after having applied a load of 100N at 167 Hz harmonic frequency

The simul 15 represents the actual resin bonded material.

### Example 5

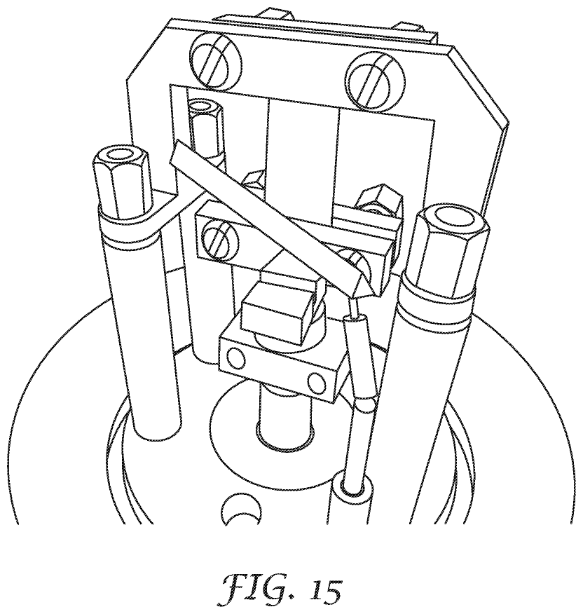

DTMA analysis was done on DTMA analyzer type V from Rheometrics Scientific with a frequency range tested of 1-5 Hz, with a temperature range: 20° C.-170° C. for the solid structure in order to determine the Tg temperature. FIG. 15 illustrates a sample mounted in a DTMA equipment. Samples were made according to the designs illustrated in FIGS. 4I, 4J and 4L.

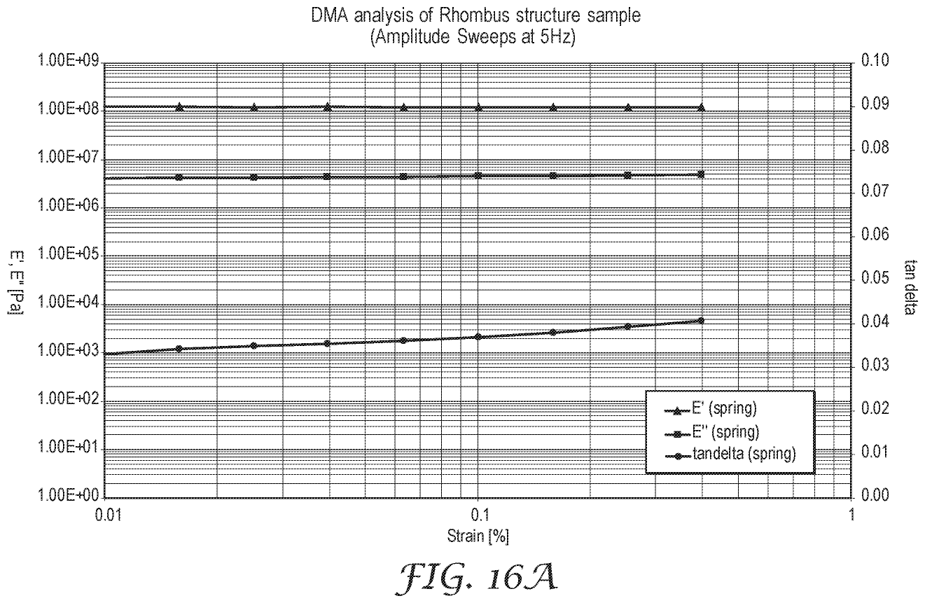

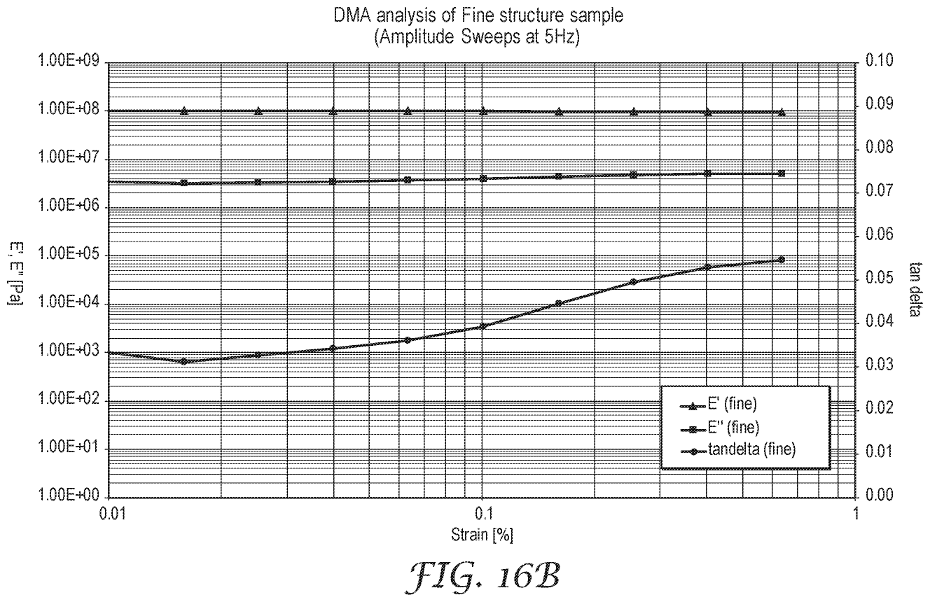

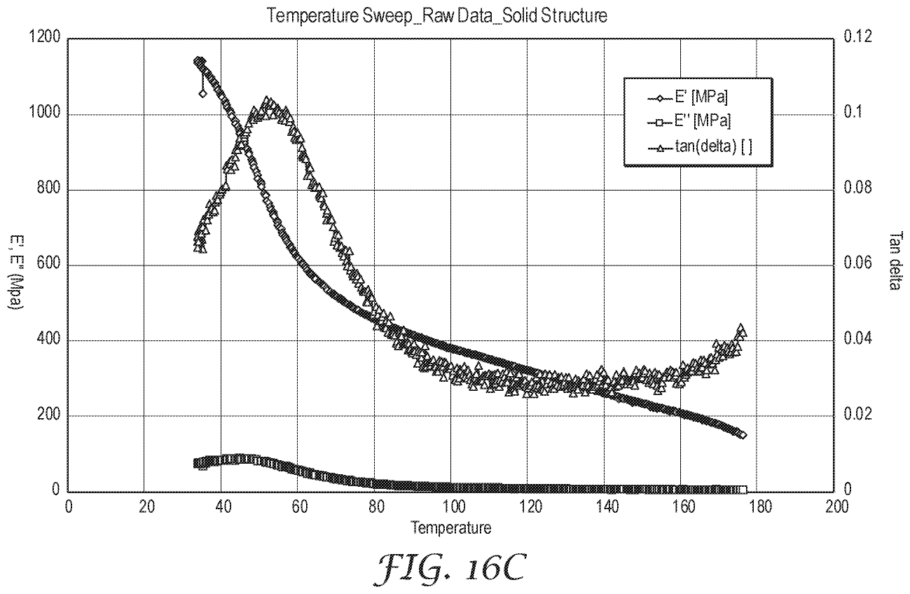

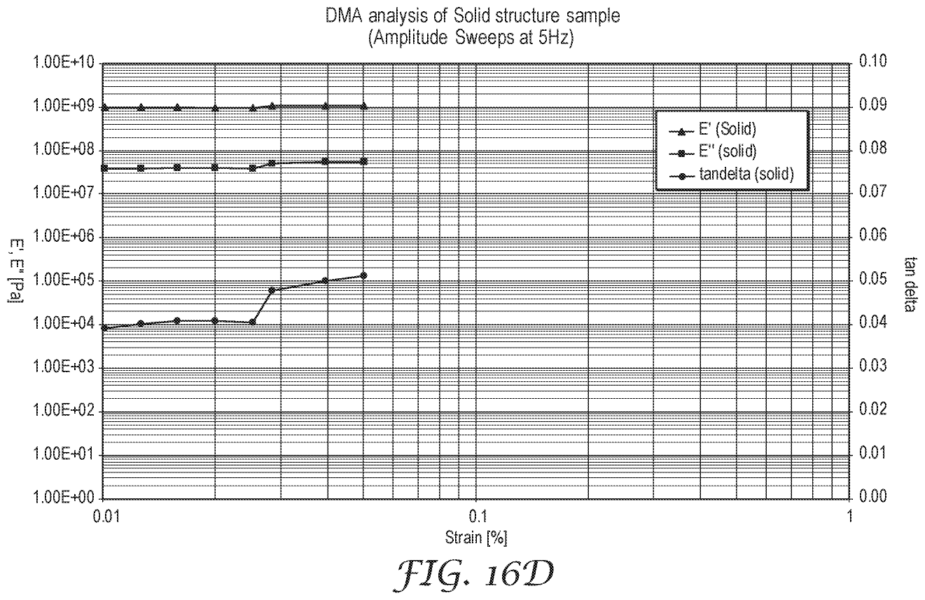

Comparison measurement were done at 5 Hz at room temperature to measure E′ (storage modulus) and E″ (loss modulus). Results are illustrated in FIG. 16. The Tg of the material was determined to be around 55° C.

Tan δ is similar for the 3 samples, showing that PA12 itself has not high damping properties.

### Example 6

Some potential modules are illustrated in FIG. 17A. A design of a reusable hub made using a honeycomb structure is illustrated in FIGS. 17B and 17C. The manufactured reusable hub is illustrated in FIGS. 17D and 17E. While unfulled in Example 6, it could also be filled with any polymer from the families of silicon, rubber (natural, butyl, butadiene, nitrile, styrene, ethylene, . . . ), polyurethane, polyethylene, polybutadiene, acrylic and polyacrylate, poly(ethyl methacrylate), copolyester, polyvinyl, epoxy, fluoroelastomer, polyether block amide, ethylene-vinyl acetate, sorbothane™ or mixture thereof The filler may be a continuous solid, a foam, or in the form of beads, either solid or hollow.

The structure is based on the repeat of a unique module in all the direction to fill the selected volume. Several types of units can be selected, given different filling ratio and different number of internal connections. Physical properties will be modified based on the selected module, the size of each module, how it is repeated (angle of propagation in X, Y or Z).

### Example 7

A rhombus structure or fine structure is designed for having high void volume ratio (more than 50%). This volume is filled with a soft material which has better damping properties than the basic structure. The filled material could be polymer from the families of silicon, rubber (natural, butyl, butadiene, nitrile, styrene, ethylene, . . . ), polyurethane, polyethylene, polybutadiene, acrylic and polyacrylate, poly(ethyl methacrylate), copolyester, polyvinyl, epoxy, fluoroelastomer, polyether block amide, ethylene-vinyl acetate, sorbothane™ or a mixture thereof. The filler may be a continuous solid, a foam, or in the form of beads, either solid or hollow.

The filling could be completed in all the voids included into the hub. A cross section of just the spring showed in this example will be similar to FIG. 18B, where the black area is the soft material having high damping properties.

The damping properties are increased in this case compare the one not using such combination. FIG. 18A illustrates a bottom part of the reusable hub having a damping structure based on filled voids. FIG. 18B illustrates a bottom part of the reusable hub having a damping structure based on filled voids including the voids around the structure.

1. A method providing damping during an abrading operation, the method comprising:
removably coupling the abrasive wheel to a hub, wherein the abrasive wheel has an outer circumference and an inner circumference, and wherein a layer of abrasive material extends between the inner and outer circumference;
abrading a worksurface by contacting the abrasive disc to the worksurface; and
wherein the hub comprises:
a housing;
a plurality of damping units within the housing; and
wherein the plurality of damping units are shaped to reduce vibrations during a grinding operation.

2. The method of claim 1, wherein the damping unit comprises metal, plastic, ceramic, rubber, a polymer, resin, or fiber-reinforced composite.

3. The method of claim 1, wherein the plurality of damping units are discrete and separately positioned about a bore receiving ring within the housing.

4. The method of claim 1, wherein the plurality of damping units are coupled together and form a single structure within the housing.

5. (canceled)

6. (canceled)

7. The method of claim 1, wherein the hub comprises a disconnecting feature.

8. (canceled)

9. The method of claim 1, wheel is removably coupled to the hub.

10. (canceled)

11. (canceled) aim 1, wherein the abrasive

12. The method of claim 1, wherein the hub comprises a first portion and a second portion, and wherein coupling comprises coupling the first portion to the second portion such that the abrasive wheel is in between the first and second portions.

13. (canceled)

14. An abrading system comprising:
an abrasive wheel comprising abrasive particles within a binder matrix, wherein the abrasive wheel comprises:
an outer circumference;
an inner circumference; and
a wheel width that extends from the outer circumference to the inner circumference; and
a hub comprising:
a housing that couples to the abrasive wheel;
a bore that receives a tool; and
a plurality of damping features within the housing, each of the plurality of damping features being shaped to reduce vibrations caused by the abrasive wheel contacting a worksurface.

15. The system of claim 14, wherein the hub comprises an upper portion and a lower portion, wherein the upper portion comprises a cover that connects to the lower portion using fasteners, and wherein the damping features are independent of the fasteners.

16. The system of claim 14, wherein the hub further comprises a disconnect feature that separates an abrasive wheel from the tool.

17. (canceled)

18. The system of claim 14, wherein the plurality of damping features each comprise a second material different from a hub material.

19. The system of claim 18, and further comprising a stiffener.

20. The system of claim 18, and wherein the damping feature comprises a filler material, and wherein the filler material differs from a polygonal structure material forming the polygonal structure.

21-24. (canceled)

25. The system of claim 14, and further comprising a locking mechanism that fixes a relative position of the hub to the abrasive wheel.

26. (canceled)

27. A hub for an abrasive article comprising:
a housing configured to couple the hub to the abrasive article, on an exterior edge of the hub, and to a machine shaft, on an interior edge of the hub; and
a vibrational damping system within the housing, the system comprising:
a plurality of damping units, each having a structure shaped to reduce vibrations; and
wherein each of the plurality of damping units are positioned within the housing.

28. The hub of claim 27, wherein the hub releasably couples to the abrasive article.

29. The hub of claim 27, wherein the hub releasably couples to the machine shaft.

30. (canceled)

31. The hub of claim 30, wherein the structure further comprises a stiffener, and wherein the stiffener comprises a stiff material that differs from a structure material forming the structure.

32. The hub of claim 30, wherein the structure comprises an aperture.

33. The hub of claim 27, and further comprising:
a disconnect feature configured to separate the abrasive article from the machine shaft.

34-38. (canceled)
